(19) United States
(12) Patent Application Publication
(10) Pub. No.: US 2021/0166208 A1
(43) Pub. Date: Jun. 3, 2021

(54) CONTROL DEVICE, SYSTEM, PROGRAM, TERMINAL DEVICE, AND PAYMENT ALLOCATING METHOD

(71) Applicant: Toyota Jidosha Kabushiki Kaisha, Toyota-shi Aichi-ken (JP)

(72) Inventor: Daiki Kaneichi, Tokyo (JP)

(73) Assignee: Toyota Jidosha Kabushiki Kaisha, Toyota-shi Aichi-ken (JP)

(21) Appl. No.: 17/015,676

(22) Filed: Sep. 9, 2020

(30) Foreign Application Priority Data
Nov. 29, 2019 (JP) 2019-217314

(51) Int. Cl. G06Q 20/10; G06Q 20/38; G06Q 20/40; G06Q 20/14

(52) U.S. Cl. CPC G06Q 20/102; G06Q 20/384; G06Q 10/02; G06Q 20/145; G06Q 20/405

(57) ABSTRACT

A control device includes a control unit that estimates a relationship of a plurality of users based on one or more instant messages exchanged by the plurality of users, and that allocates payment to the plurality of users depending on the estimated relationship, the payment being payment of a fare for a vehicle that transports the plurality of users together.

### CROSS-REFERENCE TO RELATED APPLICATION

This application claims priority to Japanese Patent Application No. 2019-217314 filed on Nov. 29, 2019, incorporated herein by reference in its entirety.

### BACKGROUND

### 1. Technical Field

The disclosure relates to a control device, a system, a program, a terminal device, and a payment allocating method.

### 2. Description of Related Art

Japanese Patent Application Publication No. 2002-342426 (JP 2002-342426 A) describes a technology in which a dispatch center obtains dispatch request information from a mobile device and sends dispatch command information to a vehicle based on the dispatch request information.

### SUMMARY

The technology described in JP 2002-342426 A does not provide a sufficient convenience as a dispatch service for a vehicle that transports a plurality of users together.

An object of the disclosure is to enhance the convenience of the dispatch service for the vehicle that transports a plurality of users together.

A control device according to the disclosure includes a control unit that estimates a relationship of a plurality of users based on one or more instant messages exchanged by the plurality of users, and that allocates payment to the plurality of users depending on the estimated relationship, the payment being payment of a fare for a vehicle that transports the plurality of users together.

A program according to the disclosure causes a computer to execute a behavior including:

receiving notice of an allocation of payment from a control device that estimates a relationship of a plurality of users based on one or more instant messages exchanged by the plurality of users, and that allocates payment to the plurality of users depending on the estimated relationship, the payment being payment of a fare for a vehicle that transports the plurality of users together;

outputting the received notice; and

giving a response indicating agreement to the allocation when accepting a user's operation for the agreement to the allocation.

A payment allocating method according to the disclosure includes:

a control device estimating a relationship of a plurality of users based on one or more instant messages exchanged by the plurality of users; and

the control device allocating payment to the plurality of users depending on the estimated relationship, the payment being payment of a fare for a vehicle that transports the plurality of users together.

The disclosure enhances the convenience of the dispatch service for the vehicle that transports a plurality of users together.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram showing the configuration of a system according to an embodiment of the disclosure;

FIG. 2 is a block diagram showing the configuration of a control device according to the embodiment of the disclosure;

FIG. 3 is a block diagram showing the configuration of a server device according to the embodiment of the disclosure;

FIG. 4 is a block diagram showing the configuration of a terminal device according to the embodiment of the disclosure;

FIG. 5 is a diagram showing a behavior of the system according to the embodiment of the disclosure;

FIG. 6 is a diagram showing the behavior of the system according to the embodiment of the disclosure; and

FIG. 7 is a diagram showing a screen example of the terminal device according to the embodiment of the disclosure.

### DETAILED DESCRIPTION

An embodiment of the disclosure will be described below with reference to the drawings.

In the drawings, identical or corresponding parts are denoted by identical reference characters. In the embodiment, descriptions of identical or corresponding parts will be omitted or simplified when appropriate.

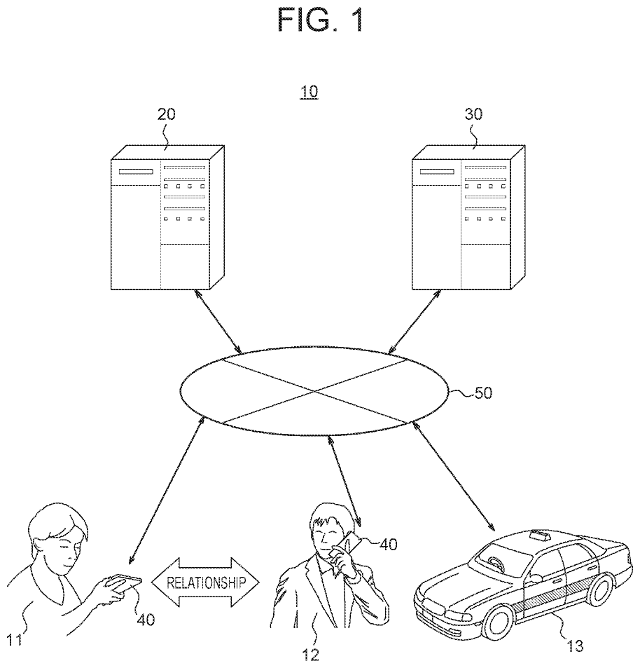

The configuration of a system 10 according to the embodiment will be described with reference to FIG. 1.

The system 10 according to the embodiment includes at least one control device 20, at least one server device 30, and terminal devices 40 of a plurality of users such as a first user 11 and a second user 12. The plurality of users may include a user other than the first user 11 and the second user 12.

The control device 20 can communicate with the server device 30 and at least one vehicle 13 through a network 50 such as the internet. The control device 20 can communicate with each terminal device 40 through the network 50.

The server device 30 can communicate with not only the control device 20 but also each terminal device 40, through the network 50. The server device 30 may be capable of communicating with the vehicle 13 through the network 50.

The control device 20 is installed in a facility such as a datacenter. For example, the control device 20 is a server that belongs to a cloud computing system or another computing system. In the embodiment, the control device 20 functions as a dispatch server that provides a dispatch service.

The server device 30 is installed in a facility such as a datacenter. For example, the server device 30 is a server that belongs to a cloud computing system or another computing system. In the embodiment, the server device 30 functions as an SNS server that provides an SNS such as an instant messaging service, to the terminal devices 40 of the plurality of users. The term “SNS” is an abbreviation of social networking service.

Each terminal device 40 is held by the user. For example, each terminal device 40 is a mobile telephone, a smartphone, a tablet or a PC. The term “PC” is an abbreviation of personal computer. In the embodiment, each terminal device 40 functions as an SNS client that uses an SNS by executing an SNS application such as an instant messenger.

For example, the vehicle 13 is an arbitrary kind of automobile such as a gasoline vehicle, a diesel vehicle, an HV, a PHV, an EV or a FCV. The term “HV” is an abbreviation of hybrid vehicle. The term “PHV” is an abbreviation of plug-in hybrid vehicle. The term “EV” is an abbreviation of electric vehicle. The term “FCV” is an abbreviation of fuel cell vehicle. The vehicle 13 is driven by a driver in the embodiment. The driving may be automated at an arbitrary level. For example, the automation level is one of Levels 1 to 5 that are defined by SAE. The term “SAE” is an abbreviation of Society of Automotive Engineers. The vehicle 13 may be a dedicated vehicle for MaaS. The term “MaaS” is an abbreviation of Mobility as a Service. In the embodiment, the vehicle 13 is an automobile such as a taxi or on-demand bus that is arranged by a dispatch service.

An outline of the embodiment will be described with reference to FIG. 1.

In the system 10 according to the embodiment, the control device 20 estimates a relationship of the plurality of users based on one or more instant messages exchanged by the plurality of users. Depending on the estimated relationship, the control device 20 allocates payment of a fare for the vehicle 13 that transports the plurality of users together, to the users.

With the embodiment, it is possible to easily decide how the payment of the fare is shared by the plurality of users, and therefore, it is possible to enhance the convenience of the dispatch service for the vehicle 13 that transports the plurality of users together.

Furthermore, in the system 10 according to the embodiment, the control device 20 performs a settlement process for the fare when the terminal devices 40 of the plurality of users accept user's operations for agreement to an allocation of the payment.

With the embodiment, when each user agrees to the allocation of the payment, the settlement of the fare is automatically performed, resulting in a further enhancement of the convenience of the dispatch service.

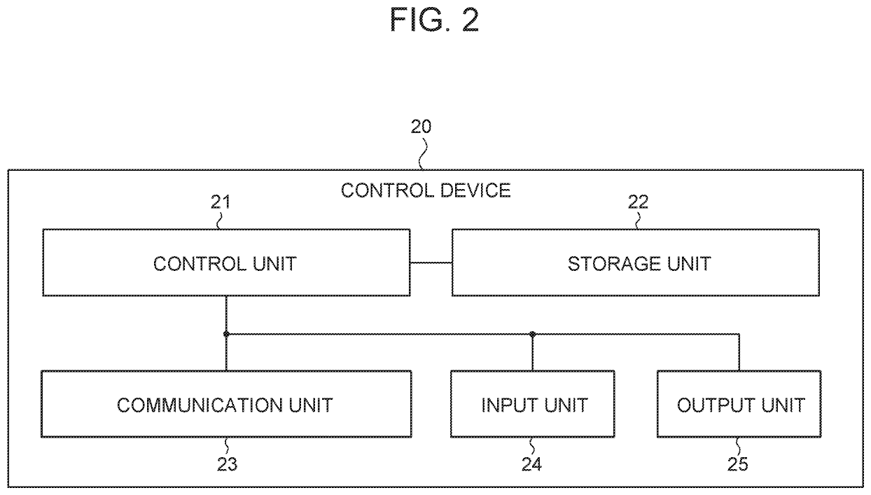

The configuration of the control device 20 according to the embodiment will be described with reference to FIG. 2.

The control device 20 includes a control unit 21, a storage unit 22, a communication unit 23, an input unit 24 and an output unit 25.

The control unit 21 includes at least one processor, at least one dedicated circuit, or a combination of the processor and the dedicated circuit. The processor is a general-purpose processor such as a CPU or a GPU, or a dedicated processor for a particular process. The term “CPU” is an abbreviation of central processing unit. The term “GPU” is an abbreviation of graphics processing unit. For example, the dedicated circuit is an FPGA or an ASIC. The term “FPGA” is an abbreviation of field-programmable gate array. The term “ASIC” is an abbreviation of application specific integrated circuit. The control unit 21 controls each unit of the control device 20, and thereby executes a process relevant to a behavior of the control device 20.

The storage unit 22 includes at least one semiconductor memory, at least one magnetic memory, at least one optical memory, or a combination of at least two of the semiconductor memory, the magnetic memory and the optical memory. For example, the semiconductor memory is a RAM or a ROM. The term “RAM” is an abbreviation of random access memory. The ROM” is an abbreviation of read only memory. For example, the RAM is an SRAM or a DRAM. The term “SRAM” is an abbreviation of static random access memory. The term “DRAM” is an abbreviation of dynamic random access memory. For example, the ROM is an EEPROM. The term “EEPROM” is an abbreviation of electrically erasable programmable read only memory. For example, the storage unit 22 functions as a main memory, an auxiliary memory or a cache memory. In the storage unit 22, data to be used for the behavior of the control device 20 and data obtained by the behavior of the control device 20 are stored.

The communication unit 23 includes at least one communication interface. For example, the communication interface is a LAN interface. The term “LAN” is an abbreviation of local area network. The communication unit 23 receives the data to be used for the behavior of the control device 20, and sends the data obtained by the behavior of the control device 20.

The input unit 24 includes at least one input interface. For example, the input interface is a physical key, a capacitive key, a pointing device, a touch screen provided integrally with a display, or a microphone. The input unit 24 accepts an operation to input the data to be used for the behavior of the control device 20. The input unit 24 may be connected to the control device 20 as an external input device, instead of being included in the control device 20. As a connection method, for example, an arbitrary method such as USB, HDMI® or Bluetooth® can be used. The term “USB” is an abbreviation of Universal Serial Bus. The term “HDMI®” is an abbreviation of High-Definition Multimedia Interface.

The output unit 25 includes at least one output interface. For example, the output interface is a display or a speaker. For example, the display is an LCD or an organic EL display. The term “LCD” is an abbreviation of liquid crystal display. The term “EL” is an abbreviation of electroluminescence. The output unit 25 outputs the data obtained by the behavior of the control device 20. The output unit 25 may be connected to the control device 20 as an external output device, instead of being included in the control device 20. As a connection method, for example, an arbitrary method such as USB, HDMI® or Bluetooth® can be used.

A function of the control device 20 is realized when a control program according to the embodiment is executed by a processor corresponding to the control unit 21. That is, the function of the control device 20 is realized by software. The control program causes a computer to execute the behavior of the control device 20, and thereby causes the computer to function as the control device 20. That is, the computer executes the behavior of the control device 20 in line with the control program, and thereby functions as the control device 20.

The program can be recorded in a computer-readable non-transitory recording medium. For example, the computer-readable non-transitory recording medium is a magnetic recording medium, an optical disk, a magneto-optical recording medium or a ROM. For example, distribution of the program is performed by sale, tradition or rental of a portable recording medium such as a DVD or CD-ROM in which the program is recorded. The term “DVD” is an abbreviation of digital versatile disk. The term “CD-ROM” is an abbreviation of compact disc read only memory. The program may be distributed by storing the program in a storage of a server and transferring the program from the server to another computer. The program may be provided as a program product.

For example, the computer temporarily stores the program recorded in the portable recording medium or the program transferred from the server, in the main memory. Then, the computer reads the grogram stored in the main memory with the processor, and executes a process in line with the read program with the processor. The computer may directly read the program from the portable recording medium, and may execute the process in line with the program. The computer may execute the process in line with the received program whenever the program is transferred from the server to the computer. Without the transfer of the program from the server to the computer, the process may be executed by a so-called ASP-type service in which the function is realized simply by execution instruction and result acquisition. The term “ASP” is an abbreviation of application service provider. The program is information that is used for processing by an electronic computer, and includes information equivalent to the program. Examples of the “information equivalent to the program” include data that is not a direct command to the computer but has a property of specifying the processing by the computer.

A part or whole of the function of the control device 20 may be realized by a dedicated circuit corresponding to the control unit 21. That is, a part or whole of the function of the control device 20 may be realized by hardware.

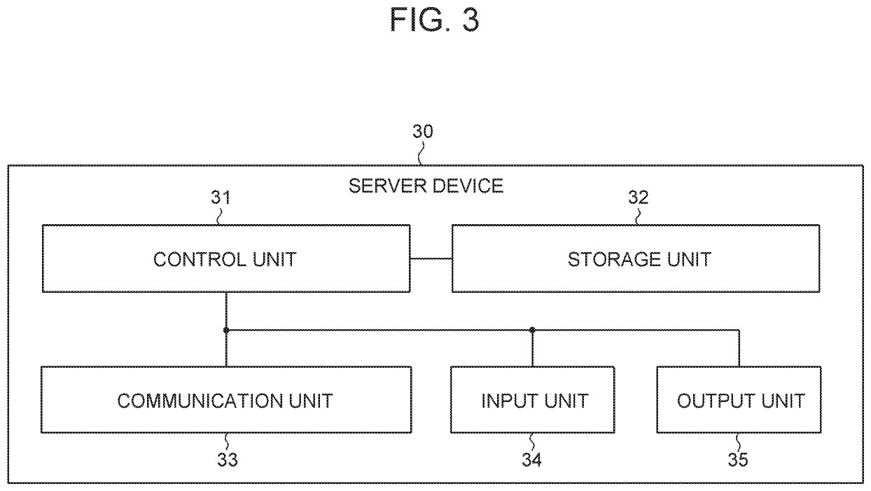

The configuration of the server device 30 according to the embodiment will be described with reference to FIG. 3.

The server device 30 includes a control unit 31, a storage unit 32, a communication unit 33, an input unit 34 and an output unit 35.

The control unit 31 includes at least one processor, at least one dedicated circuit, or a combination of the processor and the dedicated circuit. The processor is a general-purpose processor such as a CPU or a GPU, or a dedicated processor for a particular process. For example, the dedicated circuit is an FPGA or an ASIC. The control unit 31 controls each unit of the server device 30, and thereby executes a process relevant to a behavior of the server device 30.

The storage unit 32 includes at least one semiconductor memory, at least one magnetic memory, at least one optical memory, or a combination of at least two of the semiconductor memory, the magnetic memory and the optical memory. For example, the semiconductor memory is a RAM or a ROM. For example, the RAM is an SRAM or a DRAM. For example, the ROM is an EEPROM. For example, the storage unit 32 functions as a main memory, an auxiliary memory or a cache memory. In the storage unit 32, data to be used for the behavior of the server device 30 and data obtained by the behavior of the server device 30 are stored.

The communication unit 33 includes at least one communication interface. For example, the communication interface is a LAN interface. The communication unit 33 receives the data to be used for the behavior of the server device 30, and sends the data obtained by the behavior of the server device 30.

The input unit 34 includes at least one input interface. For example, the input interface is a physical key, a capacitive key, a pointing device, a touch screen provided integrally with a display, or a microphone. The input unit 34 accepts an operation to input the data to be used for the behavior of the server device 30. The input unit 34 may be connected to the server device 30 as an external input device, instead of being included in the server device 30. As a connection method, for example, an arbitrary method such as USB, HDMI® or Bluetooth® can be used.

The output unit 35 includes at least one output interface. For example, the output interface is a display or a speaker. For example, the display is an LCD or an organic EL display. The output unit 35 outputs the data obtained by the behavior of the server device 30. The output unit 35 may be connected to the server device 30 as an external output device, instead of being included in the server device 30. As a connection method, for example, an arbitrary method such as USB, HDMI® or Bluetooth® can be used.

A function of the server device 30 is realized when a server program according to the embodiment is executed by a processor corresponding to the control unit 31. That is, the function of the server device 30 is realized by software. The server program causes a computer to execute the behavior of the server device 30, and thereby causes the computer to function as the server device 30. That is, the computer executes the behavior of the server device 30 in line with the server program, and thereby functions as the server device 30.

A part or whole of the function of the server device 30 may be realized by a dedicated circuit corresponding to the control unit 31. That is, a part or whole of the function of the server device 30 may be realized by hardware.

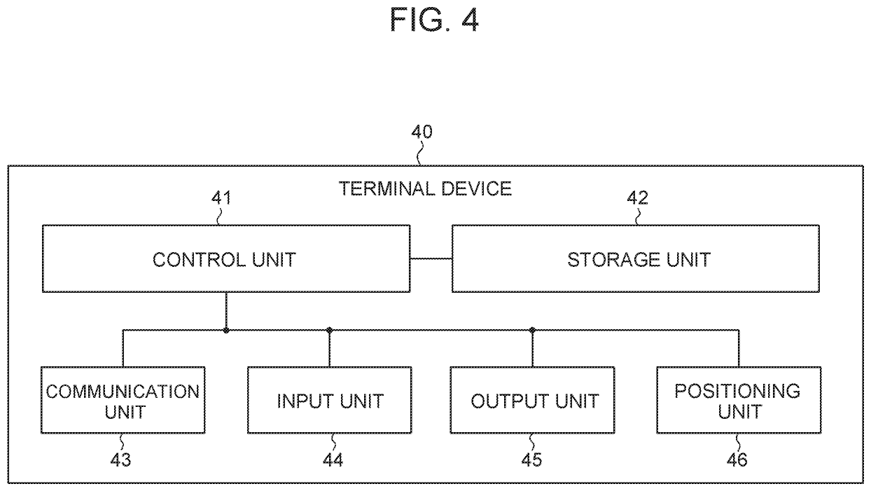

The configuration of the terminal device 40 according to the embodiment will be described with reference to FIG. 4.

The terminal device 40 includes a control unit 41, a storage unit 42, a communication unit 43, an input unit 44, an output unit 45 and a positioning unit 46.

The control unit 41 includes at least one processor, at least one dedicated circuit, or a combination of the processor and the dedicated circuit. The processor is a general-purpose processor such as a CPU or a GPU, or a dedicated processor for a particular process. For example, the dedicated circuit is an FPGA or an ASIC. The control unit 41 controls each unit of the terminal device 40, and thereby executes a process relevant to a behavior of the terminal device 40.

The storage unit 42 includes at least one semiconductor memory, at least one magnetic memory, at least one optical memory, or a combination of at least two of the semiconductor memory, the magnetic memory and the optical memory. For example, the semiconductor memory is a RAM or a ROM. For example, the RAM is an SRAM or a DRAM. For example, the ROM is an EEPROM. For example, the storage unit 42 functions as a main memory, an auxiliary memory or a cache memory. In the storage unit 42, data to be used for the behavior of the terminal device 40 and data obtained by the behavior of the terminal device 40 are stored.

The communication unit 43 includes at least one communication interface. For example, the communication interface is an interface corresponding to a mobile communication standard such as LTE, 4G or 5G, an interface corresponding to a short-range wireless communication such as Bluetooth®, or a LAN interface. The term “LTE” is an abbreviation of Long Term Evolution. The term “4G” is an abbreviation of 4th generation. The term “5G” is an abbreviation of 5th generation. The communication unit 43 receives the data to be used for the behavior of the terminal device 40, and sends the data obtained by the behavior of the terminal device 40.

The input unit 44 includes at least one input interface. For example, the input interface is a physical key, a capacitive key, a pointing device, a touch screen provided integrally with a display, or a microphone. The input unit 44 accepts an operation to input the data to be used for the behavior of the terminal device 40. The input unit 44 may be connected to the terminal device 40 as an external input device, instead of being included in the terminal device 40. As a connection method, for example, an arbitrary method such as USB, HDMI® or Bluetooth® can be used.

The output unit 45 includes at least one output interface. For example, the output interface is a display or a speaker. For example, the display is an LCD or an organic EL display. The output unit 45 outputs the data obtained by the behavior of the terminal device 40. The output unit 45 may be connected to the terminal device 40 as an external output device, instead of being included in the terminal device 40. As a connection method, for example, an arbitrary method such as USB, HDMI® or Bluetooth® can be used.

The positioning unit 46 includes at least one GNSS receiver. The term “GNSS” is an abbreviation of Global Navigation Satellite System. For example, the GNSS is GPS, QZSS, GLONASS or Galileo. The term “GPS” is an abbreviation of Global Positioning System. The term “QZSS” is an abbreviation of Quasi-Zenith Satellite System. A satellite in the QZSS is called quasi-zenith satellite. The term “GLONASS” is an abbreviation of Global Navigation Satellite System. The positioning unit 46 measures the position of the terminal device 40.

A function of the terminal device 40 is realized when a terminal program according to the embodiment is executed by a processor corresponding to the control unit 41. That is, the function of the terminal device 40 is realized by software. The terminal program causes a computer to execute the behavior of the terminal device 40, and thereby causes the computer to function as the terminal device 40. That is, the computer executes the behavior of the terminal device 40 in line with the terminal program, and thereby functions as the terminal device 40.

A part or whole of the function of the terminal device 40 may be realized by a dedicated circuit corresponding to the control unit 41. That is, apart or whole of the function of the terminal device 40 may be realized by hardware.

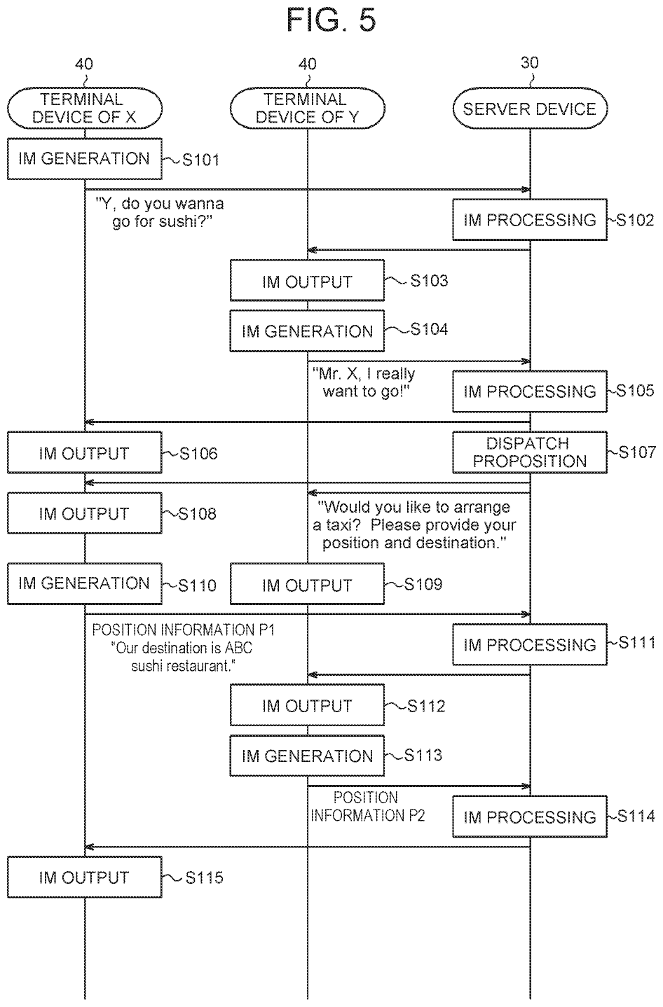

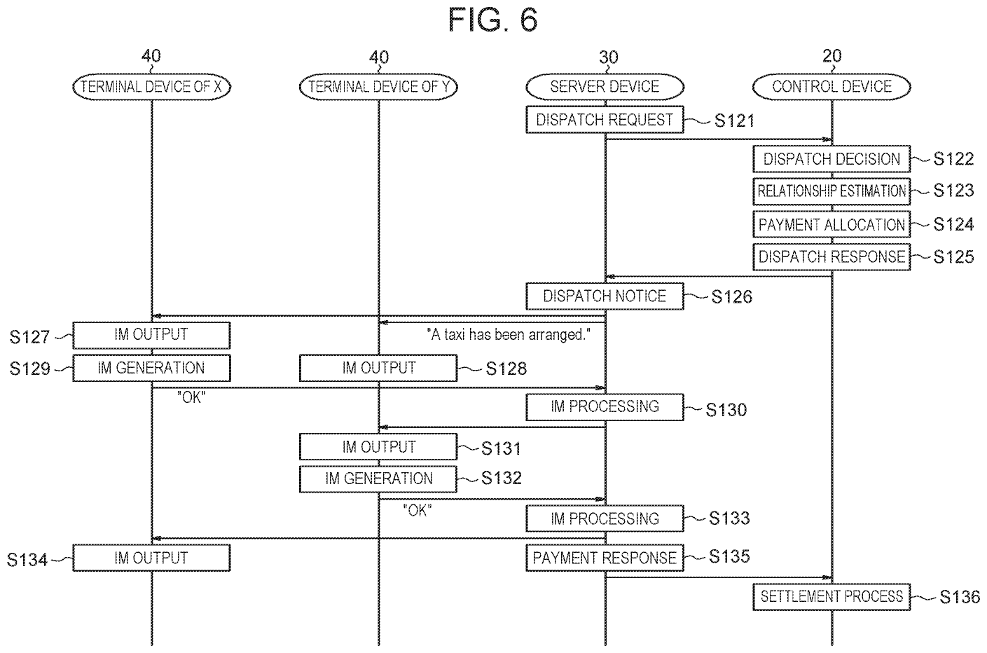

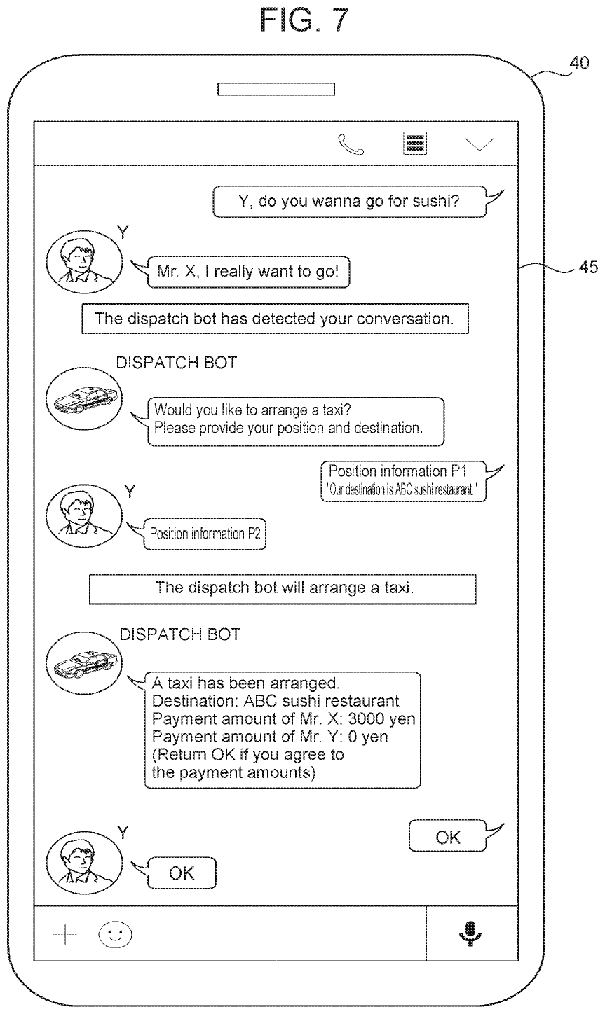

A behavior of the system 10 according to the embodiment will be described with reference to FIG. 5 and FIG. 6. The behavior corresponds to a payment allocating method according to the embodiment. In FIG. 5 and FIG. 6, an “IM” means an instant message. FIG. 7 shows a screen example of the terminal device 40 of the first user 11.

As a practical example, suppose that X who is the first user 11 and Y who is the second user 12 have a chat in the SNS by exchanging instant messages with each other. It is assumed that the vehicle 13 is a taxi. The “practical example” is an example for facilitating understanding of the embodiment, and the disclosure is not limited to the practical example.

In step S101, the control unit 41 of the terminal device 40 of X accepts an X's operation to input a text to Y, through the input unit 44. In the practical example, it is assumed that X inputs a text “Y, do you wanna go for sushi?” to the terminal device 40.

The control unit 41 outputs the input text through the output unit 45. In the embodiment, as shown in FIG. 7, the control unit 41 displays the input text on the display corresponding to the output unit 45. The control unit 41 may output the input text from the speaker corresponding to the output unit 45 by voice. The control unit 41 generates an instant message including the input text. The control unit 41 sends the generated instant message to the server device 30 through the communication unit 43.

In step S102, the control unit 31 of the server device 30 receives the instant message sent in step S101, through the communication unit 33. The control unit 31 sends the received instant message to the terminal device 40 of Y through the communication unit 33, and processes the received instant message. Specifically, the control unit 31 performs the same process as that in a conventional SNS chat, to the received instant message, and saves the text included in the received instant message, in the storage unit 32. The control unit 31 analyzes the content of the saved text, and determines whether dispatch is necessary. In the practical example, it is unknown whether X will go to eat sushi only from the question “Y, do you wanna go for sushi?”, and therefore the control unit 31 determines that the dispatch is not necessary.

In step S103, the control unit 41 of the terminal device 40 of Y receives the instant message sent in step S102, through the communication unit 43. The control unit 41 outputs the received instant message through the output unit 45. In the embodiment, the control unit 41 displays the text included in the received instant message, on the display corresponding to the output unit 45. The control unit 41 may output the text included in the received instant message, from the speaker corresponding to the output unit 45 by voice. In the practical example, the control unit 41 displays the text “Y, do you wanna go for sushi?” on the display.

In step S104, the control unit 41 of the terminal device 40 of Y accepts a Y's operation to input a text to X, through the input unit 44. In the practical example, it is assumed that Y inputs a text “Mr. X, I really want to go!” to the terminal device 40.

The control unit 41 outputs the input text through the output unit 45. In the embodiment, the control unit 41 displays the input text on the display corresponding to the output unit 45. The control unit 41 may output the input text from the speaker corresponding to the output unit 45 by voice. The control unit 41 generates an instant message including the input text. The control unit 41 sends the generated instant message to the server device 30 through the communication unit 43.

In step S105, the control unit 31 of the server device 30 receives the instant message sent in step S104, through the communication unit 33. The control unit 31 sends the received instant message to the terminal device 40 of X through the communication unit 33, and processes the received instant message. Specifically, the control unit 31 performs the same process as that in a conventional SNS chat, to the received instant message, and saves the text included in the received instant message, in the storage unit 32. The control unit 31 analyzes the content of the saved text, and determines whether the dispatch is necessary. In the practical example, since the answer “Mr. X, I really want to go!” is returned to the question “Y, do you wanna go for sushi?”, the control unit 31 can estimate that X and Y will go to eat sushi together, and therefore determines that the dispatch is necessary.

In step S106, the control unit 41 of the terminal device 40 of X receives the instant message sent in step S105, through the communication unit 43. The control unit 41 outputs the received instant message through the output unit 45. In the embodiment, the control unit 41 displays the text included in the received instant message, on the display corresponding to the output unit 45. The control unit 41 may output the text included in the received instant message, from the speaker corresponding to the output unit 45 by voice. In the practical example, the control unit 41 displays the text “Mr. X, I really want to go!” on the display.

When the control unit 31 determines that the dispatch is necessary in step S105, the control unit 31 displays or outputs by voice, for example, a system message “The dispatch bot has detected your conversation.”, on both the terminal device 40 of X and the terminal device 40 of Y. By the display or voice output of the system message, it is possible to ease a suddenness feeling of X and Y at the time of proposition of the dispatch.

In step S107, the control unit 31 of the server device 30 generates an instant message for proposing the dispatch. The control unit 31 sends the generated instant message to both the terminal device 40 of X and the terminal device 40 of Y through the communication unit 33. In the practical example, the control unit 31 sends an instant message including a text “Would you like to arrange a taxi? Please provide your position and destination.” to both the terminal device 40 of X and the terminal device 40 of Y

In step S108, the control unit 41 of the terminal device 40 of X receives the instant message sent in step S107, through the communication unit 43. The control unit 41 outputs the received instant message through the output unit 45. In the embodiment, the control unit 41 displays the text included in the received instant message, on the display corresponding to the output unit 45. The control unit 41 may output the text included in the received instant message, from the speaker corresponding to the output unit 45 by voice. In the practical example, as shown in FIG. 7, the control unit 41 displays the text “Would you like to arrange a taxi? Please provide your position and destination.” on the display.

In step S109, the control unit 41 of the terminal device 40 of Y receives the instant message sent in step S107, through the communication unit 43. The control unit 41 outputs the received instant message through the output unit 45. Details of the process in step S109 are the same as details of the process in step S108, and therefore the description is omitted.

In step S110, the control unit 41 of the terminal device 40 of X accepts an X's operation to input position information P1 about the current place and the name of a destination, through the input unit 44. The position information P1 may be directly input by the X's operation as a text of the address. Alternatively, the position information P1 may be acquired by the positioning unit 46 in line with the X's operation, and may be input by the positioning unit 46 as data such as two-dimensional coordinates or three-dimensional coordinates. In the embodiment, the current place of X is regarded as the getting-in spot of X. If X hopes to get in a taxi at a place other than the current place, position information about the getting-in spot where X hopes to get may be input instead of the position information P1 about the current place. In the embodiment, the name of the destination is explicitly input by the X's operation. The name of the destination may be implicitly input so as to be included in one or more instant messages exchanged between X and Y. In the embodiment, the destination is designated by the name. The designation may be designated by position information such as an address or coordinates. In the practical example, it is assumed that X inputs a text including the name “ABC sushi restaurant” of the destination to the terminal device 40.

The control unit 41 outputs the input position information P1 and text through the output unit 45. In the embodiment, as shown in FIG. 7, the control unit 41 displays the input position information P1 and text on the display corresponding to the output unit 45. The control unit 41 may output the input position information P1 and text from the speaker corresponding to the output unit 45 by voice. The control unit 41 generates an instant message including the input position information P1 and text. The control unit 41 sends the generated instant message to the server device 30 through the communication unit 43.

In step S111, the control unit 31 of the server device 30 receives the instant message sent in step S110, through the communication unit 33. The control unit 31 sends the received instant message to the terminal device 40 of Y through the communication unit 33, and processes the received instant message. Specifically, the control unit 31 performs the same process as that in a conventional SNS chat, to the received instant message, and saves the position information P1 and text included in the received instant message, in the storage unit 32.

In step S112, the control unit 41 of the terminal device 40 of Y receives the instant message sent in step S111, through the communication unit 43. The control unit 41 outputs the received instant message through the output unit 45. In the embodiment, the control unit 41 displays the position information P1 and text included in the received instant message, on the display corresponding to the output unit 45. The control unit 41 may output the position information P1 and text included in the received instant message, from the speaker corresponding to the output unit 45 by voice. In the practical example, the control unit 41 displays the position information P1 such as the address or coordinates of the current place of X and the text including the name “ABC sushi restaurant” of the destination, on the display.

In step S113, the control unit 41 of the terminal device 40 of Y accepts a Y's operation to input position information P2 about the current place, through the input unit 44. The position information P2 may be directly input by the Y's operation as a text of the address or the like. Alternatively, the position information P2 may be acquired by the positioning unit 46 in line with the Y's operation, and may be input by the positioning unit 46 as data such as two-dimensional coordinates or three-dimensional coordinates. In the embodiment, the current place of Y is regarded as the getting-in spot of Y. If Y hopes to get in a taxi at a place other than the current place, position information about the getting-in spot where Y hopes to get may be input instead of the position information P2 about the current place. The control unit 41 outputs the input position information P2 through the output unit 45. In the embodiment, the control unit 41 displays the input position information P2 on the display corresponding to the output unit 45. The control unit 41 may output the input position information P2 from the speaker corresponding to the output unit 45 by voice. The control unit 41 generates an instant message including the input position information P2. The control unit 41 sends the generated instant message to the server device 30 through the communication unit 43.

In step S114, the control unit 31 of the server device 30 receives the instant message sent in step S113, through the communication unit 33. The control unit 31 sends the received instant message to the terminal device 40 of X through the communication unit 33, and processes the received instant message. Specifically, the control unit 31 performs the same process as that in a conventional SNS chat, to the received instant message, and saves the position information P2 included in the received instant message, in the storage unit 32.

In step S115, the control unit 41 of the terminal device 40 of X receives the instant message sent in step S114, through the communication unit 43. The control unit 41 outputs the received instant message through the output unit 45. In the embodiment, as shown in FIG. 7, the control unit 41 displays the position information P2 included in the received instant message, on the display corresponding to the output unit 45. The control unit 41 may output the position information P2 included in the received instant message, from the speaker corresponding to the output unit 45 by voice. In the practical example, the control unit 41 displays the position information P2 such as the address or coordinates of the current place of Y, on the display.

In step S121, the control unit 31 of the server device 30 acquires the texts saved in the storage unit 32 in step S102, step S105 and step S111, the position information P1 saved in the storage unit 32 in step S111, and the position information P2 saved in the storage unit 32 in step S114. The control unit 31 generates a dispatch request including the acquired texts, including the acquired position information P1 as the position information about the getting-in spot of X, and including the acquired position information P2 as the position information about the getting-in spot of Y. The control unit 31 sends the generated dispatch request to the control device 20 through the communication unit 33. In the practical example, the control unit 31 sends, to the control device 20, the dispatch request including the text “Y, do you wanna go for sushi?”, the text “Mr. X, I really want to go!”, the text including the name “ABC sushi restaurant” of the destination, the position information P1 such as the address or coordinates of the current place of X, and the position information P2 such as the address or coordinates of the current place of Y.

In step S122, the control unit 21 of the control device 20 receives the dispatch request sent in step S121, through the communication unit 23. The control unit 21 decides the dispatch depending on the received dispatch request. Specifically, the control unit 21 monitors the position of the vehicle 13 and a service status such as information of whether there is a passenger, through the communication unit 23, and when the vehicle 13 can meet the dispatch request, the control unit 21 decides that the vehicle 13 transports X and Y together. Alternatively, the control unit 21 makes an inquiry about whether the vehicle 13 can meet the dispatch request, to the vehicle 13 or the driver of the vehicle 13 through the communication unit 23, and when the vehicle 13 or the driver of the vehicle 13 gives an answer indicating that the vehicle 13 can meet the dispatch request, the control unit 21 decides that the vehicle 13 transports X and Y together.

In step S123, the control unit 21 of the control device 20 estimates a relationship of the plurality of users based on one or more instant messages exchanged by the plurality of users.

In the embodiment, the control unit 21 analyzes the contents of the texts included in the dispatch request received in step S122, and estimates a hierarchical relationship as the relationship of X and Y. For example, the hierarchical relationship is a relationship of a superior and a subordinate, a relationship of a senior and a junior, and a relationship of an elder and a younger. In the practical example, the control unit 41 analyzes the content of the text “Y, do you wanna go for sushi?” in the instant message from X to Y and the content of the text “Mr. X, I really want to go!” in the instant message from Y to X. The control unit 41 estimates that X is a superior and Y is a subordinate, that X is a senior and Y is a junior, or that X is an elder and Y is a younger, based on a difference in politeness about calling way between “Y” and “Mr. X” and a difference in politeness about speaking way between “do you wanna go for sushi?” and “I really want to go!”.

In step S124, the control unit 21 of the control device 20 allocates, to the plurality of users, payment of a fare for the vehicle 13 that transports the plurality of users together, depending on the relationship estimated in step S123.

In the embodiment, the control unit 21 refers to the position information about the getting-in spot of X, the position information about the getting-in spot of Y and the text including the name of destination, which are included in the dispatch request received in step S122, and calculates the fare for the vehicle 13 that transports X and Y from the getting-in spot of X through the getting-in spot of Y to the destination. As a calculation method for the fare, an arbitrary method can be used. For example, using a calculation table or calculation expression for the fare for the vehicle 13, the control unit 21 calculates a fare corresponding to the total of the straight-line distance from the getting-in spot of X to the getting-in spot of Y and the straight-lie distance from the getting-in spot of Y to the destination. Alternatively, the control unit 21 searches a transportation route from the getting-in spot of X through the getting-in spot of Y to the destination, and calculates a fare corresponding to the distance of the transportation route, using the calculation table or calculation expression for the fare for the vehicle 13. As a search method for the transportation route, an arbitrary method can be used. For example, the control unit 21 independently searches the transportation route using map data that is previously stored in the storage unit 22. Alternatively, the control unit 21 searches the transportation route, using an external system such as a GIS on the internet, through the communication unit 23. The term “GIS” is an abbreviation of geographic information system. The calculation table for the fare is previously stored in the storage unit 22. The calculation expression for the fare is previously defined. In the practical example, it is assumed that the fare is 3000 yen.

The control unit 21 allocates the payment of the calculated fare to X and Y, depending on the estimated hierarchical relationship of X and Y. When the control unit 21 estimates that X and Y have no hierarchical relationship, the control unit 21 equally allocates the payment of the calculated fare to the users of X and Y. In the practical example, when it is previously decided that a superior, senior or elder pays the full amount, the control unit 21 decides that the payment amount of X is 3000 yen and the payment amount of Y is 0 yen.

In step S125, the control unit 21 of the control device 20 generates a dispatch response giving notice of the allocation of the payment decided in step S124. The control unit 21 sends the generated dispatch response to the server device 30 through the communication unit 23. In the practical example, the control unit 21 sends, to the server device 30, a dispatch response giving notice that the payment amount of X is 3000 yen and the payment amount of Y is 0 yen and notice of the name “ABC sushi restaurant” of the destination extracted from the dispatch request received in step S122.

In step S126, the control unit 31 of the server device 30 receives the dispatch response sent in step S125, through the communication unit 33. The control unit 31 generates an instant message giving notice of the dispatch along the received dispatch response. The control unit 31 sends the generated instant message to both the terminal device 40 of X and the terminal device 40 of Y through the communication unit 33. In the practical example, the control unit 31 sends an instant message including a text “A taxi has been arranged.” and giving notice that the name of the destination is “ABC sushi restaurant”, that the payment amount of X is 3000 yen, and that the payment amount of Y is 0 yen, to both the terminal device 40 of X and the terminal device 40 of Y.

In step S127, the control unit 41 of the terminal device 40 of X receives the instant message sent in step S126, through the communication unit 43, and thereby receives the notice of the allocation of the payment, from the control device 20. The control unit 41 outputs the received instant message through the output unit 45. That is, the control unit 41 outputs the received notice. In the embodiment, the control unit 41 displays the text included in the received instant message and the notice, on the display corresponding to the output unit 45. The control unit 41 may output the text included in the received instant message and the notice, from the speaker corresponding to the output unit 45 by voice. In the practical example, as shown in FIG. 7, the control unit 41 displays the text “A taxi has been arranged.” and the notice that the name of the destination is “ABC sushi restaurant”, that the payment amount of X is 3000 yen, and that the payment amount of Y is 0 yen, on the display.

In step S128, the control unit 41 of the terminal device 40 of Y receives the instant message sent in step S126, through the communication unit 43, and thereby receives the notice of the allocation of the payment, from the control device 20. The control unit 41 outputs the received instant message through the output unit 45. That is, the control unit 41 outputs the received notice. Details of the process in step S128 are the same as details of the process in step S127, and therefore the description is omitted.

In step S129, when the control unit 41 of the terminal device 40 of X accepts a user's operation for the agreement to the allocation to the notice of the allocation of the payment that is output in step S127, the control unit 41 of the terminal device 40 of X gives a response indicating the agreement to the allocation. When the control unit 41 does not accept the user's operation for the agreement to the allocation, the control unit 41 gives a response indicating disagreement to the allocation.

In the embodiment, the control unit 41 accepts an X's operation to input a text indicating the agreement to the allocation, through the input unit 44. In the practical example, it is assumed that X inputs a text “OK” to the terminal device 40.

The control unit 41 outputs the input text through the output unit 45. In the embodiment, as shown in FIG. 7, the control unit 41 displays the input text on the display corresponding to the output unit 45. The control unit 41 outputs the input text from the speaker corresponding to the output unit 45 by voice. The control unit 41 generates an instant message including the input text. The control unit 41 sends the generated instant message to the server device 30 through the communication unit 43.

In step S130, the control unit 31 of the server device 30 receives the instant message sent in step S129, through the communication unit 33. The control unit 31 sends the received instant message to the terminal device 40 of Y through the communication unit 33, and processes the received instant message. Specifically, the control unit 31 performs the same process as that in a conventional SNS chat, to the received instant message, and saves the text included in the received instant message, in the storage unit 32. The control unit 31 analyzes the content of the saved text, and determines whether X agrees to the allocation of the payment in the notice given in step S126. In the practical example, the control unit 31 determines that X agrees to the allocation of the payment, from the answer “OK”.

In step S131, the control unit 41 of the terminal device 40 of Y receives the instant message sent in step S130, through the communication unit 43. The control unit 41 outputs the received instant message through the output unit 45. In the embodiment, the control unit 41 displays the text included in the received instant message, on the display corresponding to the output unit 45. The control unit 41 may output the text included in the received instant message, from the speaker corresponding to the output unit 45 by voice. In the practical example, the control unit 41 displays the text “OK” on the display.

In step S132, when the control unit 41 of the terminal device 40 of Y accepts a user's operation for the agreement to the allocation to the notice of the allocation of the payment that is output in step S128, the control unit 41 of the terminal device 40 of Y gives a response indicating the agreement to the allocation. When the control unit 41 does not accept the user's operation for the agreement to the allocation, the control unit 41 gives a response indicating disagreement to the allocation. Details of the process in step S132 are the same as details of the process in step S129, and therefore the description is omitted.

In step S133, the control unit 31 of the server device 30 receives the instant message sent in step S132, through the communication unit 33. The control unit 31 sends the received instant message to the terminal device 40 of X through the communication unit 33, and processes the received instant message. Details of the process in step S133 are the same as details of the process in step S130, and therefore the description is omitted.

In step S134, the control unit 41 of the terminal device 40 of X receives the instant message sent in step S133, through the communication unit 43. The control unit 41 outputs the received instant message through the output unit 45. Details of the process in step S134 are the same as details of the process in step S131, and therefore the description is omitted.

In step S135, the control unit 31 of the server device 30 generates a payment response indicating a result of the determination of whether X and Y agree to the allocation of the payment in step S130 and step S133 respectively. The control unit 31 sends the generated payment response to the control device 20 through the communication unit 33. In the practical example, the control unit 31 sends a payment response indicating that X and Y agree to the allocation of the payment, to the control device 20.

In step S136, the control unit 21 of the control device 20 receives the payment response sent in step S135, through the communication unit 23. When the received payment response indicates that X and Y agree to the allocation of the payment in the notice given in step S125, the control unit 21 performs a settlement process for the fare. That is, in the case where the control unit 21 receives the response indicating the agreement to the allocation of the payment in the notice after giving the notice of the allocation of the payment to the users of X and Y, the control unit 21 performs the settlement process for the fare. As a method of the settlement process, an arbitrary method can be used. For example, the control unit 21 charges the payment amount of each user to a credit card that is previously registered by the user. In the embodiment, the control unit 21 performs a reservation process for the dispatch of the vehicle 13, along with the settlement process for the fare. As a method of the reservation process for the dispatch, an arbitrary method can be used. For example, the control unit 21 informs the vehicle 13 or the driver of the vehicle 13 of the reservation for the dispatch, through the communication unit 23.

As described above, in the embodiment, the control unit 21 of the control device 20 estimates the relationship of the plurality of users based on one or more instant message exchanged by the plurality of users. The control unit 21 allocates, to the plurality of users, the payment of the fare for the vehicle 13 that transports the plurality of users together, depending on the estimated relationship.

With the embodiment, it is possible to easily decide how the payment of the fare is shared by the plurality of users, and therefore, it is possible to enhance the convenience of the dispatch service for the vehicle 13 that transports the plurality of users together.

In the embodiment, the control unit 41 of the terminal device 40 receives the notice of the allocation of the payment, from the control device 20. The control unit 41 outputs the received notice. When the control unit 41 accepts the user's operation for the agreement to the allocation, the control unit 41 gives the response indicating the agreement of the allocation.

With the embodiment, each user does not need to think how the payment of the fare is shared by the plurality of users, resulting in the enhancement of the convenience of the dispatch service for the vehicle 13 that transports the plurality of users together.

In the embodiment, the terminal device 40 of each user is installed with a chat application allowing the taxi dispatch reservation from a chat room in which the plurality of users participates. The control device 20 analyzes the content of the chat including a text, an image or a combination of the text and the image, and thereby estimates the relationship of the plurality of users that participates in the chat. When the taxi dispatch reservation is performed, the control device 20 decides the payment ratio or payment amount of each user that participates in the chat, based on the estimated relationship. When each user agrees to the payment ratio or payment amount, the control device 20 performs electronic settlement and fixes the dispatch reservation. An arbitrary algorithm can be employed as a technique for estimating the relationship of the plurality of users from the chat content. For example, by natural language processing, the control device 20 may estimate what kinds of persons are having a conversation in the chat. For example, the control device 20 estimates that a superior and a subordinate are having a conversation. The control device 20 may consider the content of a posted image in addition to texts. For example, the control device 20 may decide the payment ratio or payment amount in consideration of the contents of stamps such as a stamp “I'll treat you today.” and a subsequent stamp “Thanks!”. The control device 20 may refer to registered user information such as company and job position, for enhancement of estimation accuracy.

As a modification of the embodiment, in step S123, the control unit 21 of the control device 20 may estimate the relationship of the plurality of users, based on only one instant message exchanged by the plurality of users. Alternatively, the control unit 21 may estimate the relationship of the plurality of users, based on three or more instant messages exchanged by the plurality of users.

For example, suppose that an instant message including a text “I'll treat you at ABC sushi restaurant today.” is sent from X to Y after the instant message including the text “Y, do you wanna go for sushi?” from X to Y and the instant message including the text “Mr. X, I really want to go!” from Y to X. In this case, by analyzing the content of the text “I'll treat you at ABC sushi restaurant today.”, it is possible to estimate a relationship in which X usually looks out for Y, and to identify the name of the destination.

As a modification of the embodiment, in step S123, the control unit 21 of the control device 20 may estimate a business relationship or a parent-child relationship instead of the hierarchical relationship. For example, the business relationship is a relation of a person that gives a business entertainment and a client that takes the business entertainment.

For example, when the control unit 21 estimates that X is a person that gives a business entertainment and Y is a client, the control unit 21 may cause X to pay the full amount. That is, the control unit 21 may allocate the payment to a user that is of the plurality of users and that is other than a user estimated to be a client. Further, when the control unit 21 estimates that X is a parent and Y is a child, the control unit 21 may cause X to pay the full amount. That is, the control unit 21 may allocate the payment to only a user that is of the plurality of users and that is estimated to be a parent.

As a modification of the embodiment, in step S123, the control unit 21 of the control device 20 may estimate the relationship of the plurality of users, based on personal data about each user, along with one or more instant messages exchanged by the plurality of users.

For example, it is assumed that the personal data includes data indicating an academic background. In this case, the relationship of a senior and a junior is easily estimated.

For example, it is assumed that the personal data includes data indicating a work experience. In this case, the relation of a superior and a subordinate or the relation of a senior and a junior is easily estimated.

As a modification of the embodiment, in step S123, the control unit 21 of the control device 20 may further estimate a payment willingness of each user, based on one or more instant messages exchanged by the plurality of users. In step S124, the control unit 21 may allocate the payment to a user that is of the plurality of users and that is estimated to have a payment willingness.

For example, suppose that the instant message including the text “I'll treat you at ABC sushi restaurant today.” is sent from X to Y after the instant message including the text “Y, do you wanna go for sushi?” from X to Y and the instant message including the text “Mr. X, I really want to go!” from Y to X. In this case, by analyzing the content of the text “I'll treat you at ABC sushi restaurant today.”, it is possible to estimate that X is willing to pay the full amount.

As a modification of the embodiment, in step S124, the control unit 21 of the control device 20 may allocate the payment of the fare to the users, by deciding payment share ratios of the users without calculating the fare. With the modification, it is not necessary to perform the settlement process for the fare in step S136, and each user can perform the settlement in the vehicle 13 by arbitrary means such as cash, the credit card or electronic money.

In the embodiment, the server device 30 provides the instant messaging service to the terminal devices 40 of the plurality of users, and the control devices 20 acquires one or more instant messages exchanged by the plurality of users, from the server device 30. As a modification of the embodiment, the server device 30 may be incorporated in the control device 20. That is, the instant messaging service may be provided to the terminal devices 40 of the plurality of users, by the control device 20.

The disclosure is not limited to the above-described embodiment. For example, a plurality of blocks described in the block diagrams may be merged, or one block may be divided. A plurality of steps described in the flowcharts may be executed in parallel or in a different order, as necessary or depending on the processing capacities of devices that execute the steps, instead of being executed in chronological order as described above. In addition, modifications can be made without departing from the spirit of the disclosure.

What is claimed is:

1. A control device comprising a control unit that estimates a relationship of a plurality of users based on one or more instant messages exchanged by the plurality of users, and that allocates payment to the plurality of users depending on the estimated relationship, the payment being payment of a fare for a vehicle that transports the plurality of users together.

2. The control device according to claim 1, wherein the control unit estimates a hierarchical relationship as the relationship of the plurality of users.

3. The control device according to claim 2, wherein the control unit equally allocates the payment to the plurality of users when it is estimated that the plurality of users have no hierarchical relationship.

4. The control device according to claim 1, wherein the control unit estimates a business relationship as the relationship of the plurality of users.

5. The control device according to claim 4, wherein the control unit allocates the payment to a user that is of the plurality of users and that is other than a user estimated to be a client.

6. The control device according to claim 1, wherein the control unit estimates a parent-child relationship as the relationship of the plurality of users.

7. The control device according to claim 1, wherein the control unit estimates the relationship of the plurality of users based on personal data about each user, along with the one or more instant messages.

8. The control device according to claim 7, wherein the personal data includes data indicating an academic background.

9. The control device according to claim 7, wherein the personal data includes data indicating a work experience.

10. The control device according to claim 1, wherein the control unit further estimates a payment willingness of each user based on the one or more instant messages, and allocates the payment to a user that is of the plurality of users and that is estimated to have the payment willingness.

11. The control device according to claim 1, wherein the control unit gives notice of an allocation of the payment to each user, and performs a settlement process for the fare when receiving a response indicating agreement to the allocation in the given notice.

12. The control device according to claim 11, wherein the control unit performs a reservation process for dispatch of the vehicle, along with the settlement process for the fare.

13. The control device according to claim 1, wherein an instant messaging service is provided to terminal devices of the plurality of users.

14. A system comprising:
the control device according to claim 13; and
the terminal devices of the plurality of users.

15. A system comprising:
a server device that provides an instant messaging service to terminal devices of the plurality of users; and
the control device according to claim 1, the control device acquiring the one or more instant messages from the server device.

16. The system according to claim 15, further comprising the terminal devices of the plurality of users.

17. A program that causes a computer to execute a behavior including:
receiving notice of an allocation of payment from a control device that estimates a relationship of a plurality of users based on one or more instant messages exchanged by the plurality of users, and that allocates payment to the plurality of users depending on the estimated relationship, the payment being payment of a fare for a vehicle that transports the plurality of users together;
outputting the received notice; and
giving a response indicating agreement to the allocation when accepting a user's operation for the agreement to the allocation.

18. A terminal device that executes the behavior in line with the program according to claim 17.

19. A payment allocating method including:
a control device estimating a relationship of a plurality of users based on one or more instant messages exchanged by the plurality of users; and
the control device allocating payment to the plurality of users depending on the estimated relationship, the payment being payment of a fare for a vehicle that transports the plurality of users together.

20. The payment allocating method according to claim 19, wherein the control device performs a settlement process for the fare when terminal devices of the plurality of users accept user's operations for agreement to an allocation of the payment.
